(19) United States
(12) Patent Application Publication
(10) Pub. No.: US 2007/0294293 A1
(43) Pub. Date: Dec. 20, 2007

(54) ENABLING GLOBAL APPLICATIONS AND SERVICES FOR CONTENT DEVICES

(75) Inventors: OREN ROSENBLOOM, REDMOND, WA (US); VLADIMIR SADOVSKY, BELLEVUE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/424,428

(22) Filed: Jun. 15, 2006

(51) Int. Cl. G06F 17/00

(52) U.S. Cl. 707/104.1

(57) ABSTRACT

Enabling global applications and services available to a user to service an action for content on a content device associated with the user is provided. A network device detects a device event for the content device. One or more applications and services available to service one or more actions for content stored on the content device are determined. The one or more applications and services may include applications installed on any of a plurality of computing devices associated with the user. The one or more applications and services may also include web services for which the user is registered. A user interface is generated based on the one or more applications and services, and the user interface is communicated for presentation.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

A wide variety of portable, personal devices are currently available to consumers for capturing, storing, and/or consuming digital content. These personal devices include digital cameras, video cameras, music players, personal data assistants (PDAs), global positioning system (GPS) devices, and mobile phones to name a few. Although the capabilities of personal devices are growing exponentially, users often wish to take advantage of software applications on other devices, such as users' home personal computers (PCs), to interact with digital content on their personal devices. For example, digital cameras typically provide only limited editing capabilities if any at all. As such, users often transfer digital images from their digital cameras to their PCs to employ image editing software available on their PCs to edit the digital images. Additionally, although the storage capacity of personal devices is also growing exponentially, it is still lagging behind the storage capacity of other devices, such as user's PCs. Accordingly, users' PCs are often the primary place for storing and organizing users' digital content.

Some software applications are currently available that include features for assisting a user in coordinating content between a personal device and another computing device, such as the user's PC. One particular feature listens for personal device arrival events, such as connecting a digital camera or a removable storage drive to a user's PC. Based on some internal heuristics, the feature prompts the user to select an application the user would like to use with the connected device. For example, in response to detecting that a digital camera has been connected to the user's PC, the feature may provide a list of photo acquisition and/or editing software applications. The list of software applications is composed based on the installed applications on the user's PC.

The above-described solution is sufficient for a user who has only one PC with all the user's applications installed on that PC. However, in today's world, users often have more than one computer with different applications resident on each computer. For example, a user may have both a desktop and a laptop computer. Additionally, users often wish to take advantage of services available on a local area network or wide area network, such as the Internet. The above-described solution, however, is limited to only providing a list of software applications available on the PC to which the personal device is connected.

Another limitation of the above-described solution is that it requires the user to physically connect the personal device to the user's PC (e.g., using a wired connection such as a universal serial bus (USB) connection or a FireWire™ connection). However, the nature of personal devices are that they are portable, and users often employ their personal devices while they are not located near their PCs. If a user is away from the location at which the user's PC is maintained (e.g., typically the user's home), the user will not be able to physically connect a personal device to the PC and take advantage of applications installed on the PC.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing a user with a list of global applications and services available to service actions for content stored on a content device. The applications may be installed on any computing device associated with the user. Additionally, the services include web services for which the user is registered. A network server may detect a device event associated with the content device. Based on the detected device event, applications and services available to the user to service actions for content stored on the content device are determined, and a user interface is generated that includes the list of applications and services. The user interface is then communicated for presentation to the user. The user may select an application or service for servicing an action for content stored on the content device.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a block diagram of an exemplary system in accordance with an embodiment of the present invention;

FIG. 3 is a flow diagram showing a method for providing a list of applications and services available for servicing an action for content stored on a content device in accordance with an embodiment of the present invention; and

FIG. 4 is a flow diagram showing a method for servicing an action for content stored on a content device in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to providing a user with a list of global applications and services available to the user to service actions associated with a content device. The applications included may be installed on any computing device associated with the user. Additionally, the services may include web services for which the user is registered. A user may thereby select any of the user's applications and services to service an action for content on the user's content device.

Accordingly, in one aspect, an embodiment of the invention is directed to a method for providing a list of one or more applications and services available to service one or more actions for content stored on a content device associated with a user. The method includes detecting, at a network device, a device event associated with the content device. The method also includes determining one or more applications and services available to service one or more actions for content stored on the content device. The applications and services include at least one of an application installed on any of a number of computing devices associated with the user and a web service for which the user is registered. The method further includes generating a user interface comprising an indication of the applications and services and communicating the user interface for presentation.

In another aspect of the invention, an embodiment is directed to a method for servicing an action for content stored on a content device. The method includes generating a user interface in response to a device event for the content device. The user interface includes a list of one or more applications and services available to service an action associated with content stored on the content device. The applications and services include at least one of an application installed on any of a number of computing devices associated with the user and a web service for which the user is registered. The method also includes receiving, via the user interface, a user selection of an application or service. The method further includes determining a location of a computing device on which the selected application or service is installed and accessing the content from the content device. The method still further includes communicating the content to the computing device and causing the computing device to launch the selected application or service to service the action for the content.

In yet a further aspect, an embodiment of the invention is directed to a computer system for providing a list of applications and services to service one or more actions for content stored on a content device. The computer system includes one or more network servers having one or more processors and one or more data stores. The data stores comprise data including an identification for one or more computing devices associated with a user. The computing devices include at least one content device associated with the user. The one or more data stores also comprise data associating one or more applications and services with the content device.

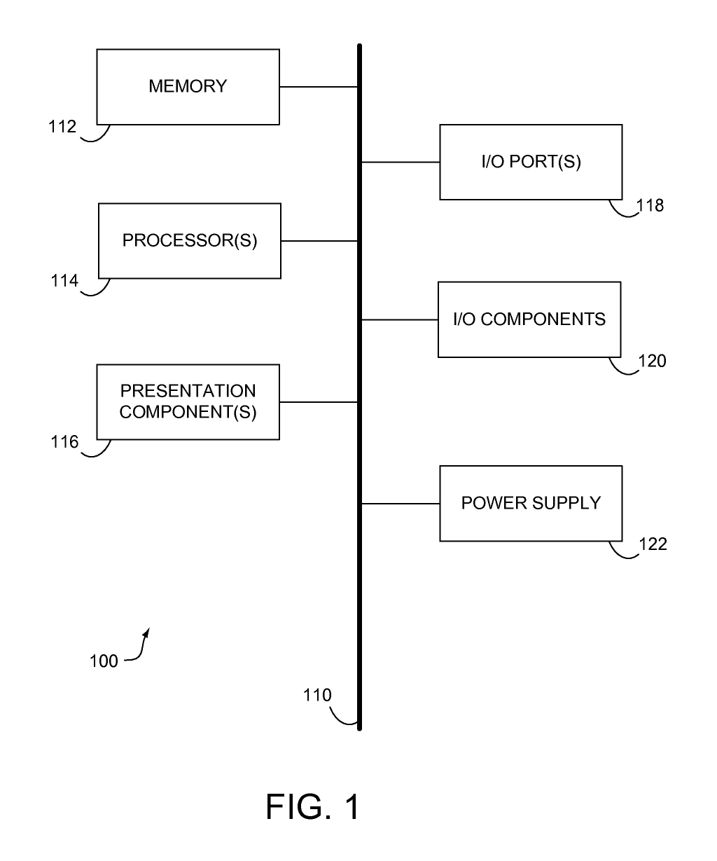

Having briefly described an overview of the present invention, an exemplary computing environment in which various aspects of the present invention may be implemented is described below in order to provide a general context for various aspects of the present invention. Referring initially to FIG. 1 in particular, an computing environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously mentioned, a user may own multiple types of computing devices, including portable, personal devices (e.g., digital cameras, video cameras, music players, PDAs, GPS devices, and mobile phones) and PCs (e.g., laptop computers and desktop computers). Each of the user's computing devices may have different installed applications. Additionally, the user may have a number of registered web services. In an embodiment, the present invention relates to enabling any of the user's locally-installed and remotely-installed applications and services to be provided in a list of applications and services available to service one or more actions for content stored on a content device associated with the user. The actions may include, for instance, storing, organizing, presenting, consuming, or otherwise interacting with content on the content device. Generally, a content device may include any type of computing device having content storage. Additionally, content may generally include media and non-media content, including, for example, audio content (e.g., music, voice recordings, or other audio content), digital still images, video images, calendar information, contact information, and document files.

Accordingly, in embodiments of the present invention, a user is transparently given the option to use whatever application the user has installed on any of the user's computing devices to service a requested action associated with content on a content device associated with the user. The applications included are independent of where the applications are installed. Additionally, the user is given the option to use any of the user's registered services, such as web services, to service a requested action associated with content on a content device. The services included are independent of the network on which the services are available. Further, in some embodiments, web services for which the user is not currently registered may be presented to the user, for example, by including advertisements in the list of applications and services. The applications, services and advertisements provided may be targeted based on the type of content being serviced.

The ability for users to access a list of applications and services to service actions associated with content on a content device may also be extended via network capabilities in embodiments of the invention. In particular, a network server may be provided for storing information regarding devices, applications, and services associated with a user. The network server may provide a list of applications and services when it detects that a content device is connected to a user's PC or is otherwise available to the network (e.g., via a wired or wireless connection). Accordingly, a user may employ any computing device having network access to communicate with the network server and be provided a list of applications and services to service actions associated with content stored on a content device.

Further, embodiments of the invention are not limited to only device arrival events but may respond to any device specific event. In one embodiment, a list of applications and services may be provided in response to any queued device event. For instance, a user may have taken a number of pictures using a digital camera. The user may wish to print one of the pictures and e-mail another of the pictures. The digital camera may store these user intents as queued device events. When the camera is connected to a computer or a network, these queued device events may then be serviced. Queued events may also include “live events.” In particular, when a device is connected to a network, one or more events may be generated and acted on in real time.

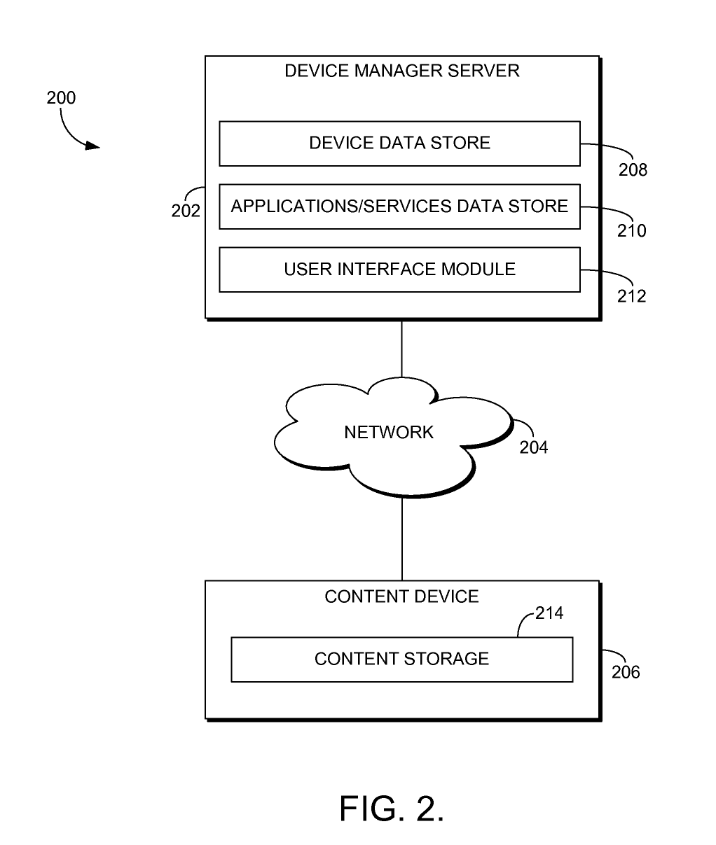

Referring now to FIG. 2, a block diagram is shown of an exemplary system 200 in which exemplary embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 2, the system 200 may include, among other components not shown, a device manager server 202 and a content device 206. By employing the system 200, a user may be provided an indication of and access to applications and services available to store, organize, consume, or otherwise interact with content stored on the content device 206. The available applications and services may be installed on any of a variety of different computing devices (not shown in FIG. 2). Components within the system 200 may communicate with each other via the network 204. The network 204 may include one or more wide area networks (WANs) and/or one or more local area networks (LANs), as well as one or more public networks, such as the Internet, and/or one or more private networks.

The device manager server 202 generally facilitates providing a list of applications and/or services to service actions for content on content devices, such as the content device 206. In particular, the device manager server 202 may track the state of content devices, such as the content device 206. For instance, the device manager server 202 may be notified when the content device 206 is available for addressing via the network 204. Additionally, the device manager server 202 may be notified of state changes of the content device 206. By tracking the state of the content device 206, the device manager server 202 may respond when the content device 206 is available and/or a state change occurs by providing a list of applications and/or services to service actions for content on the content device 206.

The device manager server 202 may include one or more data stores for maintaining data associated with user devices, applications, and services. In particular, as shown in FIG. 2, the device manager server 202 may include a device data store 208 and an applications/services data store 210. While the device data store 208 and application/services data store 210 are shown in FIG. 2 as separate components, in various embodiments of the present invention, the device manager server 202 may include one or more data stores for maintaining device data, applications data, and/or services data as described herein. For instance, in an embodiment, the data may be maintained in a single data store.

The device data store 208 stores data relating to one or more computing devices associated with a user. As indicated previously, a user may own or otherwise be associated with a variety of different computing devices, including, for instance, one or more PCs (such as a home desktop computer or a laptop computer) and one or more portable, personal devices (such as digital cameras, video cameras, music players, PDAs, GPS devices, and mobile phones). The device data store 208 stores data for each device associated with the user, including the content device 202. In some cases, data may be grouped together for devices associated with a group of users. For instance, a family may have a single account maintained by the device data store 208 that stores data for each device owned by any family member. For each device, the device data store 208 stores device information, such as, for example, the device's capabilities, which may include applications and information about the content stored on the device, but may also include identifying information such as a device icon, a manufacturing brand icon/bitmap, and any other user stored information associated with that device. In some embodiments, in addition to device data, the device data store 208 may store information about multiple user relationships, which allows routing of events as well as acts of changing ownership.

The applications/services data store 210 stores data relating to one or more applications and/or one or more services available to service actions for each content device associated with the user, such as the content device 202. As previously indicated, the user may have a variety of different applications installed on the various computing devices associated with the user. Additionally, the user may be registered with a variety of web services. In some embodiments, the applications/services data store 210 associates appropriate applications and/or services with each content device associated with the user based on the type of content stored on the content device. For instance, if the content device 206 is a digital still camera, the applications/services data store 210 may associate, with an identification of the content device 206, applications and web services for storing, organizing or printing digital still image content. In some embodiments, the applications/services data store 210 associates applications and/or services with an identification of general types of content that the applications and/or services may service. In further embodiments, the applications/services data store 210 associates applications and/or services with an identification of device event types. Any and all such variations are contemplated within the scope of the present invention. Accordingly, application selection may depend on the relationship of a content device and its content with the user.

In some embodiments, additional web services for which the user is not registered may be associated with a content device, type of content, and/or type of device event, via advertisements for the web services. For instance, in the example that the content device 206 is a digital still camera, an advertisement for an online photo printing service may be associated with the content device 206.

As shown in FIG. 2, the device manager server 202 also includes a user interface module 212. The user interface module 212 generally comprises software for generating and communicating a user interface when the user accesses the device manager server 202. The user interface may include a list of applications and/or services to service actions for one or more of the user's content devices, such as the content device 206. For instance, when a user accesses the device manager server 202, the user interface module 212 may generate and provide a user interface that includes a list of applications and/or services to service actions associated with one or more of the user's content devices, such as the content device 206.

Generally, the content device 206 may be any type of computing device having content storage 214. By way of example only and not limitation, the content device 206 may be a digital camera, video camera, music player, PDA, GPS device, mobile phones, or a PC (such as a desktop computer or a laptop computer). The content device 206 may communicate with the device manager server 202 via the network 204. In some embodiments, the content device 206 may have network capabilities for communicating with the network 204 via either a wired or wireless connection. For instance, a mobile phone may have network capabilities for communicating with the network 204. In other embodiments, the content device 206 may not have network capabilities and must rely on another computing device to communicate with the network 204. For instance, a music player may not have network capabilities but may be connected to a user's PC that has network capabilities. The PC may retrieve data from the music player (such as data associated with content stored thereon) and may communicate the data to the device manager server 202.

In embodiments of the invention in which the content device 206 has network capabilities, the content device 206 may include one or more program modules (not shown) for facilitating communication with the device manager server 202. For instance, the content device 206 may include software that allows the content device 206 to be discovered by the device manager server 202. In some embodiments, the discovery software may communicate with the device manager server 202 via the network 204 to indicate that the content device 206 is available. In other embodiments, network-based discovery protocol(s) and service(s) may be employed to detect the availability of the content device 206 and provide an indication of such availability to the device manager server 202. For instance, a presence server may be located on the network 204 for detecting the presence of the content device 206 on the network 204 and communicating the presence to the device manager server 202. The content device 206 may also include software for communicating, to the device manager server 202, information associated with content stored on the content device 206. Such software may facilitate the communication of information such as the type and amount of content stored on the content device 206. For instance, in the case that the content device 206 is a digital still camera, the software may indicate to the device server manager 202 that the content stored on the digital still camera includes digital still images and the number of images stored thereon.

In some embodiments in which the content device 206 has network capabilities, the content device 206 may also include software for accessing, from the device manager server 202, lists of applications/services to service actions for content devices associated with the user and presenting the lists to the user. For instance, in an embodiment, the content device 206 may include a client application for accessing applications/services lists from the device manager server 202. In another embodiment, the content device 206 may include a web browser for accessing and presenting applications/services lists from the device manager server 206.

As indicated hereinabove, in some embodiments, the content device 206 may communicate with the device manager server 202 by proxy, for instance, via the user's PC. In such embodiments, the content device 206 may not include any program modules for communicating with the device manager server 202. However, the content device 206 and the user's PC may be configured to communicate via a general purpose connectivity protocol, such as the Media Transfer Protocol (MTP). The user's PC may then include one or more program modules for communicating with the device manager server 202.

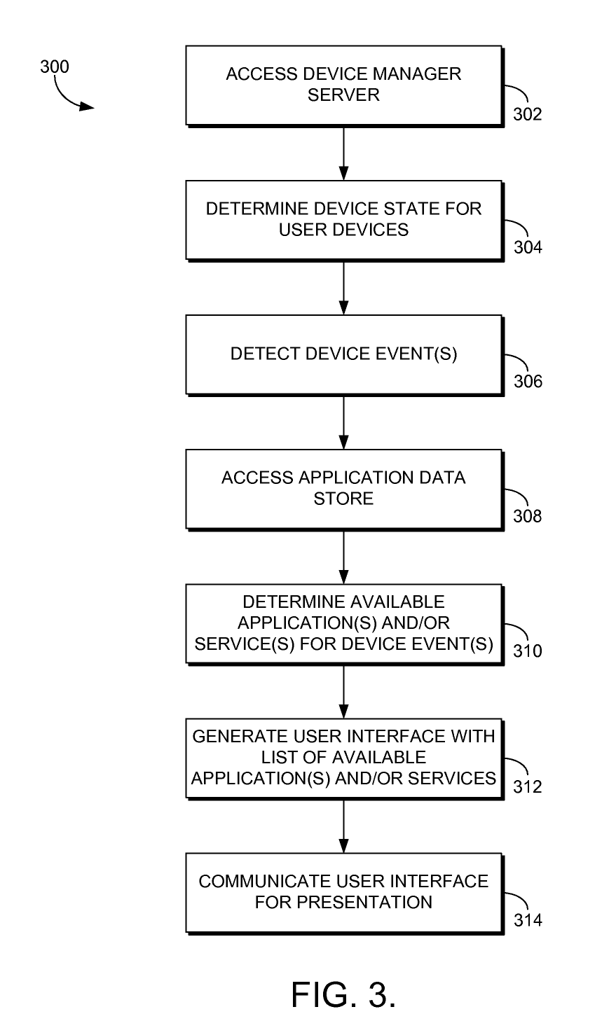

Turning now to FIG. 3, a flow diagram is illustrated that shows a method 300 for providing a list of applications and services for servicing an action for content stored on a content device in accordance with an embodiment of the present invention. Initially, as shown at block 302, a user may access a device manager server, such as the device manager server 202 of FIG. 2. Because the device manager server is a network component, the entry point for the user to access the device manager server may generally be any computing devices that has network access in various embodiments of the invention. Additionally, the user may access the device manager server in a number of different ways within the scope of the present invention. In some embodiments, a client application may be installed on a user's computing device for facilitating communication with the device manager server. When the user logs onto the user's computing device, the client application contacts the device manager server. In some embodiments, the user may use a web browser to access the device manager server. In most embodiments, when the user accesses the device manager server, some unique identifier may be required to identify the user to the device manager server. The unique identifier will allow the device manager server to determine the devices, applications, and/or services that are associated with the user. For instance, when a user accesses the device manager server using a web browser, the user may be prompted to enter a user ID and/or password.

As shown at block 304, the device state is determined for each computing device associated with the user. In some embodiments, the device manager server may store device state information, for instance, in a device data store, and may access this information to determine the device state for each device. In other embodiments, the device manager server may not maintain such information, and the device manager server or an associated device may query each device to determine device state after the user accesses the device manager server. Additionally, the device manager server detects whether there are any device events that will trigger the presentation of one or more applications and/or services to service actions associated with content on the user's content devices, as shown at block 306. A variety of different types of device events may cause the presentation of applications and/or services. For instance, in some embodiments, the availability of a content device having content stored thereon may comprise a device event. In other embodiments, a device event may occur when new content is detected on an available content device. In further embodiments, a device event may comprise a queued event stored on a content device (e.g., print this picture, email this picture, etc.). A queued event may also include a “live event,” such that when the device is connected to the network, one or more events may be generated and acted on in real time.

After detecting one or more device events, an applications/services data store, such as the applications/services data store 210 of FIG. 2, is accessed, as shown at block 308. As discussed hereinabove, an applications/services data store, such as the applications/services data store 210 of FIG. 2, may store data associating one or more applications and/or services that are available to the user to service actions for content stored on content devices for which a device event was detected. The applications included may be installed on any computing device associated with the user. Additionally, the services may be any web service for which the user is registered. In some cases, the services may include advertisements for web services for which the user is not registered. As such, based on data in the applications/services data store, available applications and/or services are determined for each device event, as shown at block 310. In various embodiments of the invention, the appropriate applications and/or service may be determined based on the content device for which a device event was detected, the type of content stored on the content device, and the type of device event.

A user interface is generated at block 312 using data accessed from the applications/services data store. The user interface may generally include a list of available applications and/or services for each device event. The user interface is communicated to the user's computing device and presented to the user, as shown at block 314.

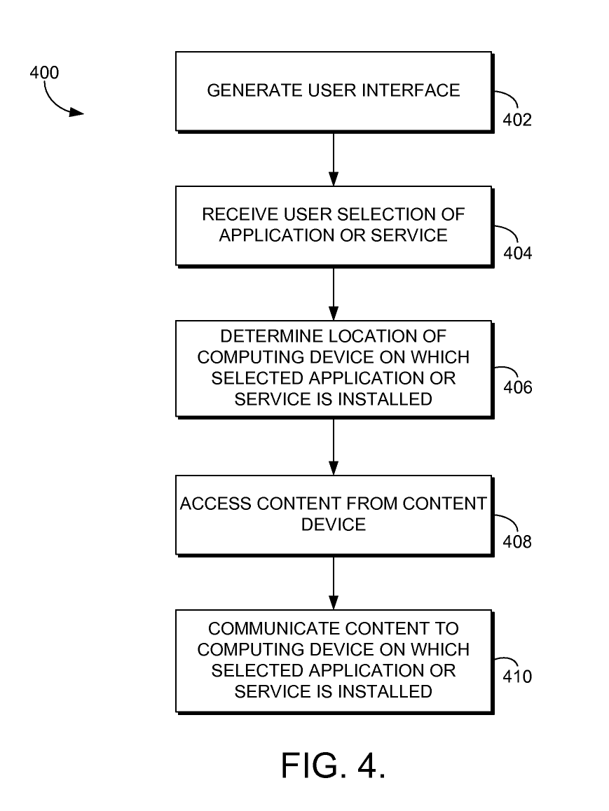

Referring now to FIG. 4, a flow diagram is provided illustrating a method 400 for servicing an action associated with content on a content device in accordance with an embodiment of the present invention. Initially, as shown at block 402, a user interface is generated. The user interface may be generated similar to the method 300 described above with reference to FIG. 3. Generally, the user interface may include one or more applications and/or services available to a user to service actions for content stored on a content device.

A user selection of an application or service to service an action for content on the content device is received via the user interface, as shown at block 404. Based on the user selection, the location of the computing device on which the selected application or service is installed is determined, as shown at block 406. Additionally, content from the content device is accessed, as shown at block 408. The content is communicated to the computing device on which the selected application or service is installed, as shown at block 410, causing the computing device to launch the selected application or service.

As can be understood, embodiments of the present invention enable global applications and services to be available to service actions for content stored on a content device. Embodiments of the present invention may service any type of device event, such as “print this photo,” “buy this song,” or “download this article,” independent of what device a user's application or a service may be located. Embodiments may also facilitate the execution of commercial transactions based on information, such as context, user account information, user preferences, device content, and device type. For example, one of the actions may be “Buy,” which may be routed to an appropriate device to facilitate the execution of a commercial transaction.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A method for providing a list of one or more applications and services available to service one or more actions for content stored on a content device associated with a user, the method comprising:
detecting, at a network device, a device event associated with the content device;
determining one or more applications and services available to service one or more actions for content stored on the content device, wherein the one or more applications and services comprise at least one of an application installed on any of a plurality of computing devices associated with the user and a web service for which the user is registered.
generating a user interface comprising an indication of the one or more applications and services; and
communicating the user interface for presentation.

2. The method of claim 1, wherein detecting a device event associated with the content device comprises determining that the content device is available and has content stored thereon.

3. The method of claim 1, wherein detecting a device event associated with the content device comprises determining that the content device is available and has at least one queued event stored thereon, the queued event specifying an action to be performed for content stored on the content device.

4. The method of claim 3, wherein determining one or more applications and services to service one or more actions for content stored on the content device comprises determining the one or more applications and services based on the action specified by the queued event.

5. The method of claim 1, wherein determining one or more applications and services to service one or more actions for content stored on the content device comprises determining the one or more applications based on the content device.

6. The method of claim 1, wherein determining one or more applications and services to service one or more actions for content stored on the content device comprises determining the one or more applications and services based on the device event.

7. The method of claim 1, wherein determining one or more applications and services to service one or more actions for content stored on the content device comprises determining a content type for the content stored on the content device and determining the one or more applications and services based on the content type.

8. The method of claim 1, wherein determining one or more applications and services to service one or more actions for content stored on the content device comprises accessing a data store comprising data associating the one or more applications and services with at least one of the content device, the device event, and a content type.

9. The method of claim 1, further comprising determining one or more advertisements based on at least one of the content device, the device event, and a content type, wherein each of the one or more advertisements is associated with a web service to service one or more actions for content stored on the content device.

10. The method of claim 9, wherein the user interface includes the one or more advertisements.

11. One or more computer-readable media having computer-useable instructions embodied thereon for performing the method of claim 1.

12. A method for servicing an action for content stored on a content device, the method comprising:
generating a user interface in response to a device event for the content device, the user interface including a list of one or more applications and services available to service an action associated with content stored on the content device, the one or more applications and services including at least one of an application installed on any of a plurality of computing devices associated with the user and a web service for which the user is registered;
receiving, via the user interface, a user selection of an application or service from the one or more applications and services;
determining a location of a computing device on which the selected application or service is installed;
accessing the content from the content device; and
communicating the content to the computing device and causing the computing device to launch the selected application or service to service the action for the content.

13. The method of claim 12, wherein receiving a user selection of an application or service from the one or more applications and services comprises receiving a user selection of an application installed on one of the plurality of computing devices associated with the user.

14. The method of claim 12, wherein receiving a user selection of an application or service from the one or more applications and services comprises receiving a user selection of a web service for which the user is registered.

15. One or more computer-readable media having computer-useable instructions embodied thereon for performing the method of claim 12.

16. A computer system for providing a list of applications and services to service one or more actions for content stored on a content device, the computer system comprising:
one or more network servers having one or more processors and one or more data stores, the one or more data stores comprising data including an identification for one or more computing devices associated with a user, the one or more computing devices including at least one content device associated with the user, the one or more data stores also comprising data associating one or more applications and services with the at least one content device.

17. The computer system of claim 16 wherein the one or more network servers further comprise a user interface module, the user interface module for generating a user interface having a list of one or more applications and services for servicing an action associated with content stored on the at least one content device.

18. The computer system of claim 16, wherein the one or more applications and services include one or more applications installed on the one or more computing devices associated with the user.

19. The computer system of claim 16, wherein the one or more applications and services include one or more registered web services for the user.

20. The computer system of claim 16, wherein the one or more applications and services include one or more advertisements for services associated with the content device.
